(19) United States
(12) Patent Application Publication
(10) Pub. No.: US 2023/0311405 A1
(43) Pub. Date: Oct. 5, 2023

(54) RETROREFLECTIVE SURFACE USING 3D PRINTING

(71) Applicant: SIGNIFY HOLDING B.V., EINDHOVEN (NL)

(72) Inventors: Rifat Ata Mustafa HIKMET, EINDHOVEN (NL); Ties VAN BOMMEL, HORST (NL); Stefan Willi Julius GRUHLKE, BAESWEILER (DE)

(21) Appl. No.: 18/022,853

(22) PCT Filed: Sep. 6, 2021
(86) PCT No.: PCT/EP2021/074478

§ 371 Date: Feb. 23, 2023

(30) Foreign Application Priority Data
Sep. 11, 2020 (EP) 20195674.5

(51) Int. Cl. B29C 64/118; B33Y 80/00; B33Y 10/00; B33Y 70/10

(52) U.S. Cl. CPC B29C 64/118; B33Y 80/00; B33Y 10/00; B33Y 70/10; B29L 2031/747

(57) ABSTRACT

A method for producing a 3D item by means of fused deposition modelling, the method comprising a 3D printing stage, wherein the 3D printing stage comprises layer-wise depositing 3D printable material (201) to provide the 3D item (1) comprising 3D printed material (202), wherein: (a) the 3D printable material (201) comprises 3D printable core material (1351) and 3D printable shell material (1361); the 3D item (1) comprises a core-shell layer (1322) of the 3D printed material (202), wherein the core-shell layer (1322) comprises (i) a core (330) comprising 3D printed core material (1352) and (ii) a shell (340) comprising 3D printed shell material (1362); wherein the shell (340) at least partly encloses the core (330); (b) the 3D printable core material (1351) is reflective or absorbing for a wavelength (21) in the visible wavelength range; and (c) the 3D printable shell material (1361) comprises shell particles (430) which are transmissive for the wavelength (21) and wherein at least part of a total number of shell particles (430) protrude from the shell (340) of the 3D printed material (202).

### FIELD OF THE INVENTION

The invention relates to a method for producing a 3D (printed) item. The invention also relates to the 3D (printed) item, such as obtainable with such method. Further, the invention relates to a lighting device including such 3D (printed) item.

### BACKGROUND OF THE INVENTION

The use of a thermoplastic polymer comprising a particulate filler for preparing 3D articles is known in the art. WO2017/040893, for instance, describes a powder composition, wherein the powder composition comprises a plurality of thermoplastic particles characterized by a bimodal particle size distribution, and wherein the powder composition may further comprise a particulate filler, antioxidant, heat stabilizer, light stabilizer, ultraviolet light stabilizer, ultraviolet light absorbing additive, near infrared light absorbing additive, infrared light absorbing additive, plasticizer, lubricant, release agent, antistatic agent, anti-fog agent, antimicrobial agent, colorant, laser marking additive, surface effect additive, radiation stabilizer, flame retardant, anti-drip agent, fragrance, fiber, or a combination comprising at least one of the foregoing, preferably a colorant or a metal particulate. This document further describes a method of preparing a three-dimensional article, the method comprising powder bed fusing the powder composition to form a three-dimensional article.

### SUMMARY OF THE INVENTION

Within the next 10-20 years, digital fabrication will increasingly transform the nature of global manufacturing. One of the aspects of digital fabrication is 3D printing. Currently, many different techniques have been developed in order to produce various 3D printed objects using various materials such as ceramics, metals and polymers. 3D printing can also be used in producing molds which can then be used for replicating objects.

For the purpose of making molds, the use of polyjet technique has been suggested. This technique makes use of layer by layer deposition of photo-polymerizable material which is cured after each deposition to form a solid structure. While this technique produces smooth surfaces the photo curable materials are not very stable, and they also have relatively low thermal conductivity to be useful for injection molding applications.

The most widely used additive manufacturing technology is the process known as Fused Deposition Modeling (FDM). Fused deposition modeling (FDM) is an additive manufacturing technology commonly used for modeling, prototyping, and production applications. FDM works on an “additive” principle by laying down material in layers; a plastic filament or metal wire is unwound from a coil and supplies material to produce a part. Possibly, (for thermoplastics for example) the filament is melted and extruded before being laid down. FDM is a rapid prototyping technology. Other terms for FDM are “fused filament fabrication” (FFF) or “filament 3D printing” (FDP), which are considered to be equivalent to FDM. In general, FDM printers use a thermoplastic filament, which is heated to its melting point and then extruded, layer by layer, (or in fact filament after filament) to create a three-dimensional object. FDM printers are relatively fast, low cost and can be used for printing complicated 3D objects. Such printers are used in printing various shapes using various polymers. The technique is also being further developed in the production of LED luminaires and lighting solutions.

It appears desirable to produce items, such as luminaires, with a retroreflective surface. This may be desirable for controlling light distributions, to create light effects, for distinguishing surfaces, for (traffic) signs, safety reflection elements, etc. Further, it appears desirable to control the surface structure during the printing of the object.

Hence, it is an aspect of the invention to provide an alternative 3D printing method and/or 3D (printed) item which preferably further at least partly obviate(s) one or more of above-described drawbacks. The present invention may have as object to overcome or ameliorate at least one of the disadvantages of the prior art, or to provide a useful alternative.

Hence, in a first aspect the invention provides a method for producing a 3D item by means of fused deposition modelling. Especially, the method may comprise a 3D printing stage comprising layer-wise depositing an extrudate comprising 3D printable material, to provide the 3D item of 3D printed material. In embodiments, the 3D printable material comprises 3D printable core material and 3D printable shell material, to provide the 3D item comprising a core-shell layer, wherein the core-shell layer comprises (i) a core comprising 3D printed core material and (ii) a shell comprising 3D printed shell material. In embodiments, the shell partly or fully encloses the core. Especially, in embodiments the shell may fully enclose the core. In specific embodiments, the 3D printable core material may be reflective or absorbing for one or more wavelengths in the visible wavelength range. In embodiments, the 3D printable shell material comprises shell particles having particle sizes, wherein the shell particles may be transmissive for one or more of the one or more wavelengths in the visible wavelength range. Especially, the shell particles may be transparent for one or more of the one or more wavelengths in the visible wavelength range. The method may further comprise selecting a shell width W2 in relation to the particle sizes such that at least part of a total number of particles protrude from the shell of the 3D printed material. Thereby, a retroreflective 3D item may be provided. Hence, in specific embodiments the invention provides a method for producing a 3D item by means of fused deposition modelling, the method comprising a 3D printing stage, wherein the 3D printing stage comprises layer-wise depositing 3D printable material to provide the 3D item comprising 3D printed material, wherein: (a) the 3D printable material comprises 3D printable core material and 3D printable shell material; the 3D item comprises a core-shell layer of the 3D printed material, wherein the core-shell layer comprises (i) a core comprising 3D printed core material and (ii) a shell comprising 3D printed shell material; wherein the shell at least partly encloses the core; and (b) the 3D printable shell material comprises shell particles which are transparent for a wavelength in the visible wavelength range and wherein at least part of a total number of shell particles protrude from the shell of the 3D printed material.

In this way, it may be possible to create retroreflective items that may be applied in e.g. safety measures, traffic signs, or for one or more of (i) decorative, and (ii) optical effects that may in embodiments differ over the 3D printed item (surface). Especially, items that are retroreflective for white light (thus for all colors of white light) may be created.

The term “retroreflective” may especially refer to reflecting at least part of the radiation of a source of irradiation back to the source of irradiation, more especially reflecting one or more wavelengths in the visible light range back to the light source. A retroreflective item, which may also be called a retroreflector, may be an item, device, element (such as beads), or surface, that reflects radiation, especially light, back to its source with relatively low scattering. This may work at a wide range of angle of incidence. Being directed, the retroreflector's reflection may be brighter than that of a diffuse reflector.

In embodiments, part of a total number of shell particles may be protruding the shell. Additionally, part of the total number of shell particles may be fully embedded in the printable shell material. The amount of reflectivity may depend on the coverage of shell particles of the shell surface. In embodiments, at least 5% of the light may be reflected using the principle of a retroreflector. In specific embodiments at least 8%, especially at least 10% of the light may be reflected. However, larger amounts may also be possible.

Retroreflective properties may especially be achieved when the shell particles are transparent, and when the shell material, especially the thermoplastic material comprised by the shell material, has a different index of refraction than the shell particles. In embodiments, the index of refraction of the (thermoplastic material of the) shell material may be larger (than of the particles), in yet other embodiments, the index of refraction of the shell material may be smaller (than of the particles). Especially, the latter may be the case.

In embodiments, the 3D printable shell material (and thus the 3D printed shell material), especially the thermoplastic material, may absorb at least part of the light having one or more wavelengths in the visible range, whereas the shell particles may be transmissive or transparent for at least part of the light having the one or more wavelengths in the visible range. For instance, the 3D printable shell material, the thermoplastic material may be colored and/or the 3D printable material may comprise a colorant, such as a dye or pigment (which may be dispersed in the thermoplastic material.

Alternatively or additionally, in embodiments the 3D printable shell material (and thus the 3D printed shell material), especially the thermoplastic material, may be light transmissive for at least part of the light having one or more wavelengths in the visible range, while the shell particles may also be transmissive or transparent for at least part of the light having the one or more wavelengths in the visible range.

Alternatively or additionally, in embodiments the 3D printable shell material (and thus the 3D printed shell material), especially the thermoplastic material, may be light transmissive for at least part of the light having one or more wavelengths in the visible range, but may also be light reflective for (the) light having one or more wavelengths in the visible range, while the shell particles may also be transmissive or transparent for at least part of the light having the one or more wavelengths in the visible range. For instance, the 3D printable shell material, the thermoplastic material may light transmissive and may comprise light reflective particles (in addition to the shell particles) (which may be dispersed in the thermoplastic material. Hence, in such embodiments the shell particles may be mainly used for retroreflection and the light reflective particles for reflection.

Assuming that the printable shell material (and thus the 3D printed shell material) is transmissive for one or more wavelengths in the visible (such as one or more of the one or more wavelengths for which the shell particles are light transmissive or transparent, reflection and/or absorption of light at the core may also be visible.

Therefore, in specific embodiments the 3D printable core material (and thus the 3D printed core) may be one or more of absorbing or reflecting. Alternatively, the 3D printable core material (and thus the 3D printed core) may be (fully) light transmissive.

In embodiments, the thermoplastic material of the 3D printable core material may be light transmissive and may comprise light reflective particles (which may be dispersed in the thermoplastic material. Alternatively or additionally, the 3D printable core material, especially the thermoplastic material thereof, may be colored and/or the 3D printable material may comprise a colorant, such as a dye or pigment (which may be dispersed in the thermoplastic material (of the 3D printable core material)).

Therefore, in embodiments the printable shell material may be light transmissive, especially light transparent, for one or more wavelengths in the visible wavelength rage. Especially, in embodiments the printable shell material is light transparent for one or more of the one or more wavelengths that are reflected or absorbed by the 3D printable core material (and/or transmitted by the shell particles). Thus, in specific embodiments, the printable shell material is light transmissive, especially light transparent for one or more wavelengths in the visible, especially for those one or more wavelengths in the visible that may be reflected or absorbed by the 3D printed core material.

Here, the phrases “a wavelength in the visible wavelength range” “the wavelength” or “one or more wavelengths”, and similar phrases, may especially indicate one wavelength or multiple wavelengths. Hence, the terms “a wavelength” or “the wavelength” in phrases like “transparent for a wavelength” or “transmissive for the wavelength”, or “reflective for the wavelength” or “retroreflective for the wavelength”, and similar phrases, may especially refer to a plurality of wavelengths, such as a wavelength range of at least 100 nm, especially at least 250 nm, such as at least 300 nm (within the range of 380-780 nm).

Especially, in embodiments a light transmissive material has a light transmission in the range of 50-100%, especially in the range of 70-100%, for light having a wavelength selected from the visible wavelength range. Herein, the term “visible light” especially relates to light having a wavelength selected from the range of 380-780 nm.

Hence, for instance, the shell particles may be transparent for wavelengths in a wavelength range of at least 100 nm (within the visible wavelength range). Hence, at any wavelength in the range, the shell particle may be transparent. For instance, at any wavelength in the range, the transmission may be at least 50%.

Especially, a light absorbing material has a light absorbance in the range of 50-100%, especially in the range of 70-100%, for light having a wavelength selected from the visible wavelength range. As can be derived from the above, this may apply for a wavelength range of at least 100 nm, especially at least 250 nm, such as at least 300 nm (within the range of 380-780 nm).

Especially, a light reflective material has a light reflectivity in the range of 50-100%, especially in the range of 70-100%, for light having a wavelength selected from the visible wavelength range. As can be derived from the above, this may apply for a wavelength range of at least 100 nm, especially at least 250 nm, such as at least 300 nm (within the range of 380-780 nm).

Note that a material may be reflective for one or more first wavelengths and absorb one or more second wavelengths, which may be the case with colored material. Herein, the term “light absorbing material” especially refers to a colored material or to a black material. The term “light reflective material may herein especially refer to a white material or metallic reflective material, i.e. materials which have a relatively high reflection, such as at least 70%, over a relatively high wavelength range, such as at least 100 nm, even more especially at least 250 nm, such as at least 300 nm, within the range of 380-780 nm.

The transmission T (or light permeability) can be determined by providing light at a specific wavelength with a first intensity I₁ to the light transmissive material under perpendicular radiation and relating the intensity of the light I₂ at that wavelength measured after transmission through the material, to the first intensity of the light provided at that specific wavelength to the material, thus T=I₂/I₁. Likewise, the reflectivity R can be determined by relating the intensity of the light I₃ at that wavelength measured after reflection by the material, to the first intensity of the light I₁ provided at that specific wavelength to the material. Thus R=I₃/I₁. The absorbance A may in embodiments be defined as A=1−(T+R) (see also E-208 and E-406 of the CRC Handbook of Chemistry and Physics, 69th edition, 1088-1989).

In specific embodiments, a material may be considered transmissive when the transmission of the radiation at a wavelength or in a wavelength range is larger than the reflectivity and absorbance (at that wavelength or in that wavelength range), thus when T>R and T>A, especially wherein T/R≥1.2 and T/A≥1.2. In specific embodiments, a material may be considered reflective when the reflectivity of the radiation at a wavelength or in a wavelength range is larger than the transmission and absorbance (at that wavelength or in that wavelength range), thus when R>T and R>A, especially wherein R/I≥1.2 and R/A≥1.2. In specific embodiments, a material may be considered absorbing when the absorbance of the radiation at a wavelength or in a wavelength range is larger than the transmission and reflectivity (at that wavelength or in that wavelength range), thus when A>T and A>R, especially wherein A/T≥1.2 and A/R≥1.2. Here, T, R, and A refer to percentages.

In specific embodiments, a material may be considered transmissive when the transmission of the radiation at a wavelength or in a wavelength range, especially at a wavelength or in a wavelength range of radiation generated by a source of radiation as herein described, through a 1 mm thick layer of the material, especially even through a 5 mm thick layer of the material, under perpendicular irradiation with said radiation is at least about 20%, such as at least 40%, like at least 60%, such as especially at least 80%, such as at least about 85%, such as even at least about 90%.

The light transmissive material has light guiding or wave guiding properties. Hence, the light transmissive material is herein also indicated as waveguide material or light guide material. The light transmissive material will in general have (some) transmission of one or more of (N)UV, visible and (N)IR radiation, such as in embodiments at least visible light, in a direction perpendicular to the length of the light transmissive material.

The transmission of the light transmissive material (as such) for one or more luminescence wavelengths may be at least 80%/cm, such as at least 90%/cm, even more especially at least 95%/cm, such as at least 98%/cm, such as at least 99%/cm. This implies that e.g. a 1 cm³ cubic shaped piece of light transmissive material, under perpendicular irradiation of radiation having a selected luminescence wavelength (such as a wavelength corresponding to an emission maximum of the luminescence of the luminescent material of the light transmissive material), will have a transmission of at least 95%.

Herein, values for transmission especially refer to transmission without taking into account Fresnel losses at interfaces (with e.g. air). Hence, the term “transmission” especially refers to the internal transmission. The internal transmission may e.g. be determined by measuring the transmission of two or more bodies having a different width over which the transmission is measured. Then, based on such measurements the contribution of Fresnel reflection losses and (consequently) the internal transmission can be determined. Hence, especially, the values for transmission indicated herein, disregard Fresnel losses.

In embodiments, an anti-reflection coating may be applied to the luminescent body, such as to suppress Fresnel reflection losses (during the light incoupling process).

In addition to a high transmission for the wavelength(s) of interest, also the scattering for the wavelength(s) may especially be low. Hence, the mean free path for the wavelength of interest only taking into account scattering effects (thus not taking into account possible absorption may be at least 0.5 times the length of the body, such as at least the length of the body, like at least twice the length of the body. For instance, in embodiments the mean free path only taking into account scattering effects may be at least 5 mm, such as at least 10 mm. The wavelength of interest may especially be the wavelength at maximum emission of the luminescence of the luminescent material. The term “mean free path” is especially the average distance a ray will travel before experiencing a scattering event that will change its propagation direction.

In embodiments, the element comprising the light transmissive material may essentially consist of the light transmissive material. In specific embodiments, the element comprising the light transmissive material may be a light transparent element. Especially, the light transmittance is similar for all wavelengths in the visible wavelength range.

Especially, the light transmissive element, such as the light transparent element, may in embodiments have an absorption length and/or a scatter length of at least the length (or thickness) of the light transmissive element, such as at least twice the length of the light transmissive element. The absorption length may be defined as the length over which the intensity of the light along a propagation direction due to absorption drops with 1/e. Likewise, the scatter length may be defined as the length along a propagation direction along which light is lost due to scattering and drops thereby with a factor 1/e. Here, the length may thus especially refer to the distance between a first face and a second face of the light transmissive element, with the light transmissive material configured between the first face and second face.

Herein, when an element is indicated to be transmissive this may in embodiments imply that at one or more wavelengths the part of the radiation that is transmitted may be larger than the part of the radiation that is reflected or absorbed. Herein, when an element is indicated to be reflective this may in embodiments imply that at one or more wavelengths the part of the radiation that is reflected may be larger than the part of the radiation that is transmitted or absorbed.

In embodiments, the shell particles may at least partly be randomly distributed through the shell material. In thinner shells, thus at lower W2 values, in relation to the particle sizes, more particles may protrude from the shell of the 3D printed material and thus may protrude from the 3D printed item. Especially, when the shell width W2 is smaller than the particle sizes (see also below), the shell particles may protrude from the shell of the 3D printed material and thus may protrude from the 3D printed item. In embodiments, the method may comprise selecting the shell width W2 in relation to the particle sizes such that at least 20 vol. %, especially at least 40 vol. %, of the shell particles protrude from the shell of the 3D printed material to provide a retroreflective 3D item.

Here, the phrase “protrude from the shell”, and similar phrases, may especially indicate that parts of particles protrude from the shell and thus protrude from the surface from the layer. It is not excluded that particles may also protrude from the shell into the core, but the phrase “protrude from the shell” especially refers to protruding from the surface from the (3D printed) layer. Hence, in embodiments at least part of the total number of shell particles may protrude from the thermoplastic material.

The number of protruding shell particles as well as a volume of the shell particles that protrudes the shell, may depend on the shell width W2 in relation to the shell particle sizes. In embodiments, particle sizes are defined by an equivalent spherical diameter. The equivalent spherical diameter (or ESD) of an (irregularly) shaped object is the diameter of a sphere of equivalent volume. Hence, the equivalent spherical diameter (ESD) of a cube with a side a is

$$2 * a * \sqrt[3]{3 / ( 4 * π )} .$$

Would a sphere in an xyz-coordinate system with a diameter D be distorted to any other shape (in the xyz-plane), without changing the volume, than the equivalent circular diameter of that shape would be D. The equivalent circular diameter (or ECD) of an (irregularly shaped) two-dimensional shape is the diameter of a circle of equivalent area. For instance, the equivalent circular diameter of a square with side a is 2*a*SQRT(1/π). For a circle, the diameter is the same as the equivalent circular diameter. Would a circle in an xy-plane with a diameter D be distorted to any other shape (in the xy-plane), without changing the area size, than the equivalent circular diameter of that shape would be D. In embodiments, the shell particles may have an equivalent spherical diameter D1, wherein 30 μm≤D1≤2000 μm, such as in embodiments 30 μm≤D1≤1000 μm. Especially, in embodiments 60 μm≤D1≤850 μm, more especially wherein 80 μm≤D1≤700 μm. The shell particle sizes may affect the appearance of the 3D item. Smaller shell particles, especially 30 μm≤D1≤250 μm, may provide subtle twinkling, whereas larger shell particles, especially 400 μm≤D1≤1000 μm, may provide mini reflectors. In embodiments, a mix of shell particle dimensions may be used. Shell particle sizes are especially selected such that the shell particles can pass the printer nozzle without clog formation.

In embodiments, the method comprises selecting the shell width W2 in relation to the equivalent spherical diameter D1 to obtain a ratio of 0.25≤D1/W2≤2.5, in specific embodiments 0.5≤D1/W2≤1.5. In embodiments, D1/W2≥1.25, or even D1/W2≥1. Especially, in embodiments 0.5≤D1/W2≤1.5, then shell particles may protrude from the shell and a retroreflective surface may be obtained. Additionally, the shape of the particles may influence the number of protruding particles as well as the volume of the particles that protrudes the shell. In embodiments, the particles may be spherical, ellipsoid, cubic, prismoid, flakes, or irregularly shaped.

In embodiments, the shell particles and the 3D printable shell material may be repellent of one another. In this way, protrusion of the shell particles from the shell may be facilitated. In embodiments, the shell particles may be hydrophilic or have a hydrophilic coating in a hydrophobic 3D printable shell material. Alternatively, the opposite may be the case. In embodiments, the shell particles may be hydrophobic or have a hydrophobic coating in a hydrophilic 3D printable shell material.

In embodiments, the shell particles have a refractive index selected from the range of 1.4-2.5, especially in embodiments in the range of 1.5-1.9. Especially, the shell particles and the (thermoplastic material of the) 3D printable (or printed) shell material may not have the same refractive index. In embodiments, the difference in refractive index may be at least 0.05, like at least 0.1, like in the range 0.1-1.3, such as 0.1-0.5. In specific embodiments, the difference in refractive index may be at least 0.15. In specific embodiments, the difference in refractive index is at least 0.2, such as in the range of 0.2-1.3, like 0.2-0.8. In embodiments, the shell particles may have a larger index of refraction than the thermoplastic material of the shell material, wherein the particles are (at least partly) embedded.

Hence, in embodiments the 3D printable shell material (and the 3D printed shell material) comprise a (shell) thermoplastic material with shell particles, wherein the shell particles may have a first refractive index and the (shell) thermoplastic material may have a second refractive index, wherein the first refractive index and second refractive index differs with at least 0.15. Instead of the term “refractive index” also the term “index of refraction” may be applied. The difference may mean that one is larger than the other or that one is smaller than the other.

The difference of the refractive index may refer to the standard wavelength used for determining the index of refraction, i.e. at the yellow doublet sodium D line, with a wavelength of 589 nm (more precisely 589.29 nm).

In embodiments, the shell particles comprise one or more of (i) glass beads (especially in embodiments barium titanate glass beads), (ii) polymer spheres, and (iii) quartz spheres. Common glass beads may have a relatively low refractive index, usually in the range 1.5-1.6. These may be of interest as they may be easily handled. Barium titanate glass beads may have a high refractive index, such as in embodiments in the range 1.8-1.9, and may provide an increased brightness compared to common glass beads. Further, with such materials a large index of refraction difference may be obtained (with the 3D printable or 3D printed shell material. Other light transmissive high index of refraction materials may also be used as shell particles.

In embodiments, the 3D printable core material is reflective for the wavelength. Additionally or alternatively, the 3D printable core material is absorbing for the wavelength. In embodiments, the core printable material comprises core particles. The core particles and shell particles may each be individually described by a smallest rectangular prism circumscribing the respective particles. Such rectangular prism has a length L₁, a width L₂ and a height L₃, wherein L₁≥L₂≥L₃, wherein such rectangular prism has a first aspect ratio is AR₁=L₁/L₂, a second aspect ratio is AR₂=L₁/L₃, and a third aspect ratio is AR₃=L₂/L₃. In specific embodiments, the 3D printable core material is reflective or absorbing for the wavelength, wherein the core printable material comprises core particles, wherein the core particles and shell particles are each individually described by a smallest rectangular prism circumscribing the respective particles, wherein such rectangular prism has a length L₁, a width L₂ and a height L₃, wherein L₁≥L₂≥L₃, wherein such rectangular prism has a first aspect ratio is AR₁=L₁/L₂, a second aspect ratio is AR₂=L₁/L₃, and a third aspect ratio is AR₃=L₂/L₃.

Specific embodiments for the core particles (if available) and for the shell particles are described below.

In embodiments, the core particles are reflective for one or more wavelengths. The core particles may described by a length L_{1,1} and a second aspect ratio AR_{1,2}. In embodiments, length L_{1,1} is in the range from 1-1000 μm, especially in the range from 5-500 μm, more especially in the range from 10-300 μm. In embodiments AR_{1,2}≥10, especially AR_{1,2}≥20, more especially AR_{1,2}≥40. Especially, the core particles may have a reflectivity R for the wavelength, wherein R>70%, especially R>80%, more especially R>85%. In specific embodiments, the core particles are reflective for the wavelength, wherein the core particles are described by a length L_{1,1} and a second aspect ratio AR_{1,2}, wherein length L_{1,1} is in the range from 1-1000 μm, wherein AR_{1,2}≥10. Hence, in embodiments the core particles may e.g. be reflective flakes. Especially, such particles may render the 3D printable core material or the 3D printed core material a high reflectively. Therefore, the 3D printable core material (and the 3D printed core material) may comprise a light transmissive thermoplastic material, with reflective core particles (embedded therein).

As indicated above, the core material alternatively or additionally may comprise additives that may be absorbing for one or more wavelengths. Hence, in embodiments the core particles may be absorbing for the wavelength, and the core particles may be described by a length L_{1,1}, a width L_{1,2}, a height L_{1,3}, a first aspect ratio AR_{1,1}, a second aspect ratio AR_{1,2} and a third aspect ratio AR_{1,3}. In embodiments, length L_{1,1} is in the range from 1-100 μm, especially in the range from 5-80 μm, more especially in the range from 10-60 μm. Hence, in embodiments L_{1,2} may be in the range of 0.5-50 μm. Alternatively or additionally, in embodiments L_{1,3} may be in the range of 0.5-50 μm. In embodiments, AR_{1,1}≤2, AR_{1,2}≤2, and AR_{1,3}≤2. Thus, in specific embodiments the core particles are absorbing for the wavelength, wherein the core particles are described by a length L_{1,1} and a first aspect ratio AR_{1,1}, a second aspect ratio AR_{1,2} and a third aspect ratio AR_{1,3}, wherein length L_{1,1} is in the range from 1-100 μm and wherein AR_{1,1}≤2, AR_{1,2}≤2, and AR_{1,3}≤2.

Alternatively or additionally, the 3D printable core material (and 3D printed core material) may comprise a dye, which may provide a color, or which may provide a white 3D printable core material (and 3D printed core material).

Combinations of two or more reflective particles, colored particles, and dyes may also be applied. In yet further specific embodiments (see also above), the 3D printable core material (and 3D printed core material) is light transmissive and does essentially not contain light reflective or light absorbing particles (or a dye).

Here below, further embodiments of the shell particles are described.

Substantially elongated shell particles may align with the core and may therefore be less likely to protrude from the shell. Therefore, in embodiments, shell particles with aspect ratios around about 1 are selected. Especially, the shell particles may be described by a length L_{2,1}, a width L_{2,2}, a height L_{2,3}, a first aspect ratio AR_{2,1}, a second aspect ratio AR_{2,2}, and a third aspect ratio AR_{2,3}. In embodiments, the length L_{2,1} is in the range from 30-2000 μm, especially in the range from 30-1000 μm. In embodiments, AR_{2,1}≤2, AR_{2,2}≤2, and AR_{2,3}≤2. Hence, in embodiments L_{2,2} may be in the range of 15-1000 μm. Alternatively or additionally, in embodiments L_{2,3} may be in the range of 15-1000 μm. Hence, in specific embodiments, the shell particles are described by a length L₂j, a first aspect ratio AR_{2,1}, a second aspect ratio AR_{2,2}, and a third aspect ratio AR_{2,3} wherein length L_{2,1} is in the range from 30-2000 μm and wherein AR_{2,1}≤2, AR_{2,2}≤2, and AR_{2,3}≤2.

Sizes may be determined with methods known in the art, like one or more of optical microscopy, SEM and TEM. Dimensions may be number averaged, as known in the art. Further, the aspect ratios indicated above may refer to a plurality of particles having different aspect ratios. Hence, the particles may be substantially identical, but the particles may also mutually differ, such as two or more subsets of particles, wherein within the subsets the particles are substantially identical. The particles may have a unimodal particle size distribution or a polymodal size distribution.

The particles may thus mutually differ. For instance, the particles may have a distribution of the sizes of one or more of the particle length, the particle height, and an intermediate length. Therefore, in embodiments in average, the particles will have dimensions as described herein. For instance, at least 50 wt % of the particles may comply with the herein indicated dimensions (including ratios), such as at least 75 wt %, like at least 85 wt %. In alternative embodiments, at least 50% of the total number of particles may comply with the herein indicated dimensions (including ratios), such as at least 75%, like at least 85%.

The thermoplastic material of the shell may comprise one or more different (thermoplastic) shell polymeric materials. Likewise, the thermoplastic material of the core may comprise one or more different (thermoplastic) core polymeric materials. In embodiments, the one or more different (thermoplastic) shell polymeric materials and the one or more different (thermoplastic) core polymeric materials are essentially the same, though the shell material and the core material may differ in (embedded) particles. In alternative embodiments, the one or more different (thermoplastic) shell polymeric materials and the one or more different (thermoplastic) core polymeric materials are different, such as e.g. PMMA and PC. In yet alternative embodiments one or more of two or more different (thermoplastic) shell polymeric materials and one or more of two or more different (thermoplastic) core polymeric materials may be same, while one or more of two or more different (thermoplastic) shell polymeric materials and one or more of two or more different (thermoplastic) core polymeric materials may be different, such as a shell comprising PMMA and PC, and a core comprising PET and PMMA.

Different polymeric materials may respond differently to temperature changes. The 3D printable (or printed) material may have different temperatures at different stages of the printing process. In embodiments, the 3D printable material has a temperature T₁ when residing in the printer nozzle, whilst after printing, the 3D printed material adapts an ambient temperature T₂. In embodiments, T₁>T₂.

In embodiments, the 3D printed core material has a volume V_{1,1} at the temperature T₁ and a volume V_{1,2} at the temperature T₂ and a shrinkage S₁=(V_{1,1}−V_{1,2})/V_{1,1}. In embodiments, the 3D printed shell material has a volume V_{2,1} at the temperature T₁ and a volume V_{2,2} at the temperature T₂ and a shrinkage S₂=(V_{2,1}−V_{2,2})/V_{2,1}. In embodiments, S₂−S₁≥0.001, especially S₂−S₁≥0.002, more especially S₂−S₁≥0.005.

Thus, in specific embodiments, the shrinkage of the 3D printed shell material is higher than the shrinkage of the 3D printed core material.

As indicated above, the method may in embodiments also provide variation in one or more of (i) decorative, and (ii) optical effects while the material composition may essentially be the same. Therefore, the 3D printing stage may comprise a second stage, wherein the second stage comprises one or more of (i) selecting the shell width W2 in relation to the equivalent spherical diameter D1 to obtain a ratio of D1/W2<0.5, or even D1/W2<0.25, (ii) providing second 3D printable shell material comprising particles in an amount reduced relative to the 3D printable shell material. This second stage may provide a less retroreflective surface of the 3D printed item as fewer particles may be protruding and as the total volume percentage of protruding particles may be less compared to the first stage described previously.

The term “first stage” and “second stage” and similar phrases, may refer to any order of first and second stages. Further, during 3D printing there may be a plurality of changes between first and second stage, or second and first stage, etc.

In embodiments, the core and shell may comprise the same thermoplastic material. When the particle size is not changed, changes in D1/W2 may be obtained by controlling (i) the extrusion rate of the 3D printable material, (ii) the extrusion rate of the 3D printable shell material relative to the extrusion rate of the 3D printable core material, and (iii) a relative velocity of the printer nozzle and the substrate.

Note that the method may in embodiments comprise one or more first stages and one or more second stages. Especially, in embodiments the method may comprise a plurality of first stages and a plurality of second stages. In yet other embodiments, the method may in embodiments only comprise the first stage. In yet other embodiments, the method may in embodiments only comprise a single first stage and a single second stage.

In embodiments, during part of the 3D printing stage, the shell width W2 may be 0 μm, thus providing a layer that only comprises the core material. Especially, the core width W1 thus equals layer width W.

In embodiments, relative to a total volume of the 3D printable material, the volume percentage of the particulate material is selected from the range of 15-60 vol. %. Consequently, relative to a total volume of the 3D printed material, the volume percentage of the particulate material is selected from the range of 15-60 vol. %. Hence, relative to a total volume of the 3D printable material or the 3D printed material, the volume percentage of the particulate material (relative to the 3D printable material or the 3D printed material, respectively) is selected from the range of 15-60 vol. %. Smaller values than about 15 vol. %, such as smaller than 10 vol. %, may not have the desired retroreflective effect, larger values than about 60 vol. %, such as larger than about 70 vol. % may become very difficult to print. In embodiments, the remainder of the volume may be polymeric material, and optionally other fillers (see also below).

As indicated herein, the 3D item is especially generated by layer-wise deposition of layers. When referring to the concentration of the particles during deposition of the filaments or after deposition of the filaments, the concentration especially refers to at least part of such filament, or at least part of the deposited layer. Hence, the concentration of the particles may vary over the length of the filament or may vary over a length of a layer, or differ between layers. It is even possible that there are layers without particles and layers with particles. The smallest (integral) volume for which the concentration applies is especially at least 1 cm³, such as at least 2 cm³, like at least 5 cm³. Of course, this may be a relative extended volume, as the height and width of the layers are in general relatively small.

As indicated above, the method comprises depositing during a printing stage 3D printable material. Herein, the term “3D printable material” refers to the material to be deposited or printed, and the term “3D printed material” refers to the material that is obtained after deposition. These materials may be essentially the same, as the 3D printable material may especially refer to the material in a printer head or extruder at elevated temperature and the 3D printed material refers to the same material, but in a later stage when deposited. The 3D printable material is printed as a filament and deposited as such. The 3D printable material may be provided as filament or may be formed into a filament. Hence, whatever starting materials are applied, a filament comprising 3D printable material is provided by the printer head and 3D printed. The term “extrudate” may be used to define the 3D printable material downstream of the printer head, but not yet deposited. The latter is indicated as “3D printed material”. In fact, the extrudate comprises 3D printable material, as the material is not yet deposited. Upon deposition of the 3D printable material or extrudate, the material is thus indicated as 3D printed material. Essentially, the materials are the same material, as the thermoplastic material upstream of the printer head, downstream of the printer head, and when deposited, is essentially the same material.

Herein, the term “3D printable material” may also be indicated as “printable material. The term “polymeric material” may in embodiments refer to a blend of different polymers but may in embodiments also refer to essentially a single polymer type with different polymer chain lengths. Hence, the terms “polymeric material” or “polymer” may refer to a single type of polymers but may also refer to a plurality of different polymers. The term “printable material” may refer to a single type of printable material but may also refer to a plurality of different printable materials. The term “printed material” may refer to a single type of printed material but may also refer to a plurality of different printed materials.

Hence, the term “3D printable material” may also refer to a combination of two or more materials. In general, these (polymeric) materials have a glass transition temperature T_{g} and/or a melting temperature Tₘ. The 3D printable material will be heated by the 3D printer before it leaves the nozzle to a temperature of at least the glass transition temperature, and in general at least the melting temperature. Hence, in a specific embodiment the 3D printable material comprises a thermoplastic polymer having a glass transition temperature (T_{g}) and/or a melting point (Tₘ), and the printer head action comprises heating the 3D printable material above the glass transition and if it is a semi-crystalline polymer above the melting temperature. In yet another embodiment, the 3D printable material comprises a (thermoplastic) polymer having a melting point (Tₘ), and the printer head action comprises heating the 3D printable material to be deposited on the receiver item to a temperature of at least the melting point. The glass transition temperature is in general not the same thing as the melting temperature. Melting is a transition which occurs in crystalline polymers. Melting happens when the polymer chains fall out of their crystal structures and become a disordered liquid. The glass transition is a transition which happens to amorphous polymers; that is, polymers whose chains are not arranged in ordered crystals, but are just strewn around in any fashion, even though they are in the solid state. Polymers can be amorphous, essentially having a glass transition temperature and not a melting temperature or can be (semi) crystalline, in general having both a glass transition temperature and a melting temperature, with in general the latter being larger than the former. The glass temperature may e.g. be determined with differential scanning calorimetry. The melting point or melting temperature can also be determined with differential scanning calorimetry.

As indicated above, the invention thus provides a method comprising providing a filament of 3D printable material and printing during a printing stage said 3D printable material on a substrate, to provide said 3D item.

A filament for producing a 3D item by means of fused deposition modelling may comprise a core comprising a printable core material. The filament may also comprise a shell comprising a printable shell material. The printable shell material may comprise shell particles, wherein the shell particles may be transmissive for one or more wavelengths in the visible wavelength range. Especially, the shell particles may be transparent for one or more wavelengths in the visible wavelength range.

A filament for producing a 3D item by means of fused deposition modelling may comprise: (i) a core comprising a printable core material; and (ii) a shell comprising a printable shell material, wherein the printable shell material comprises shell particles which are transparent for a wavelength in the visible wavelength range. Note that the shell particles may not protrude from the filament, but by controlling one or more of (i) extrusion rate, (ii) relative velocity of the printer nozzle and the substrate, and (iii) shrinkage of the shell thermoplastic material, the particles may protrude from the 3D printed material (see also above).

In this way, it may be possible to prepare retroreflective 3D printed items whilst starting from a previously prepared filament.

Materials that may especially qualify as 3D printable materials may be selected from the group consisting of metals, glasses, thermoplastic polymers, silicones, etc. Especially, the 3D printable material comprises a (thermoplastic) polymer selected from the group consisting of ABS (acrylonitrile butadiene styrene), Nylon (or polyamide), Acetate (or cellulose), PLA (poly lactic acid), terephthalate (such as PET polyethylene terephthalate), Acrylic (polymethylacrylate, Perspex, polymethylmethacrylate, PMMA), Polypropylene (or polypropene), Polycarbonate (PC), Polystyrene (PS), PE (such as expanded-high impact-Polythene (or polyethene), Low density (LDPE) High density (HDPE)), PVC (polyvinyl chloride) Polychloroethene, such as thermoplastic elastomer based on copolyester elastomers, polyurethane elastomers, polyamide elastomers polyolefine based elastomers, styrene based elastomers, etc. Optionally, the 3D printable material comprises a 3D printable material selected from the group consisting of Urea formaldehyde, Polyester resin, Epoxy resin, Melamine formaldehyde, thermoplastic elastomer, etc. Optionally, the 3D printable material comprises a 3D printable material selected from the group consisting of a polysulfone. Elastomers, especially thermoplastic elastomers, are especially interesting as they are flexible and may help obtaining relatively more flexible filaments comprising the thermally conductive material. A thermoplastic elastomer may comprise one or more of styrenic block copolymers (TPS (TPE-s)), thermoplastic polyolefin elastomers (TPO (TPE-o)), thermoplastic vulcanizates (TPV (TPE-v or TPV)), thermoplastic polyurethanes (TPU (TPU)), thermoplastic copolyesters (TPC (TPE-E)), and thermoplastic polyamides (TPA (TPE-A)).

Suitable thermoplastic materials, such as also mentioned in WO2017/040893, may include one or more of polyacetals (e.g., polyoxyethylene and polyoxymethylene), poly(C₁₋₆ alkyl)acrylates, polyacrylamides, polyamides, (e.g., aliphatic polyamides, polyphthalamides, and polyaramides), polyamideimides, polyanhydrides, polyarylates, polyarylene ethers (e.g., polyphenylene ethers), polyarylene sulfides (e.g., polyphenylene sulfides), polyarylsulfones (e.g., polyphenylene sulfones), polybenzothiazoles, polybenzoxazoles, polycarbonates (including polycarbonate copolymers such as polycarbonate-siloxanes, polycarbonate-esters, and polycarbonate-ester-siloxanes), polyesters (e.g., polycarbonates, polyethylene terephthalates, polyethylene naphtholates, polybutylene terephthalates, polyarylates), and polyester copolymers such as polyester-ethers), polyetheretherketones, polyetherimides (including copolymers such as polyetherimide-siloxane copolymers), polyetherketoneketones, polyetherketones, polyethersulfones, polyimides (including copolymers such as polyimide-siloxane copolymers), poly(Ci-alkyl)methacrylates, polymethacrylamides, polynorbomenes (including copolymers containing norbomenyl units), polyolefins (e.g., polyethylenes, polypropylenes, polytetrafluoroethylenes, and their copolymers, for example ethylene-alpha-olefin copolymers), polyoxadiazoles, polyoxymethylenes, polyphthalides, polysilazanes, polysiloxanes, polystyrenes (including copolymers such as acrylonitrile-butadiene-styrene (ABS) and methyl methacrylate-butadiene-styrene (MBS)), polysulfides, polysulfonamides, polysulfonates, polysulfones, polythioesters, polytriazines, polyureas, polyurethanes, polyvinyl alcohols, polyvinyl esters, polyvinyl ethers, polyvinyl halides, polyvinyl ketones, polyvinyl thioethers, polyvinylidene fluorides, or the like, or a combination comprising at least one of the foregoing thermoplastic polymers. Embodiments of polyamides may include, but are not limited to, synthetic linear polyaamides, e.g., Nylon-6,6; Nylon-6,9; Nylon-6,10; Nylon-6,12; Nylon-11; Nylon-12 and Nylon-4,6, preferably Nylon 6 and Nylon 6,6, or a combination comprising at least one of the foregoing. Polyurethanes that can be used include aliphatic, cycloaliphatic, aromatic, and polycyclic polyurethanes, including those described above. Also useful are poly(C₁₋₆ alkyl)acrylates and poly(C₁₋₆ alkyl)methacrylates, which include, for instance, polymers of methyl acrylate, ethyl acrylate, acrylamide, methacrylic acid, methyl methacrylate, n-butyl acrylate, and ethyl acrylate, etc. In embodiments, a polyolefine may include one or more of polyethylene, polypropylene, polybutylene, polymethylpentene (and co-polymers thereof), polynorbomene (and co-polymers thereof), poly 1-butene, poly(3-methylbutene), poly(4-methylpentene) and copolymers of ethylene with propylene, 1-butene, 1-hexene, 1-octene, 1-decene, 4-methyl-1-pentene and 1-octadecene.

In specific embodiments, the 3D printable material (and the 3D printed material) comprise one or more of polycarbonate (PC), polyethylene (PE), high-density polyethylene (HDPE), polypropylene (PP), polyoxymethylene (POM), polyethylene naphthalate (PEN), styrene-acrylonitrile resin (SAN), polysulfone (PSU), polyphenylene sulfide (PPS), and semi-crystalline polytethylene terephthalate (PET), acrylonitrile butadiene styrene (ABS), poly(methyl methacrylate) (PMMA), polystyrene (PS), and styrene acrylic copolymers (SMMA).

The term 3D printable material is further also elucidated below, but especially refers to a thermoplastic material, optionally including additives, to a volume percentage of at maximum about 60%, especially at maximum about 30 vol. %, such as at maximum 20 vol. % (of the additives relative to the total volume of the thermoplastic material and additives).

The printable material may thus in embodiments comprise two phases. The printable material may comprise a phase of printable polymeric material, especially thermoplastic material (see also below), which phase is especially an essentially continuous phase. In this continuous phase of thermoplastic material polymer additives such as one or more of antioxidant, heat stabilizer, light stabilizer, ultraviolet light stabilizer, ultraviolet light absorbing additive, near infrared light absorbing additive, infrared light absorbing additive, plasticizer, lubricant, release agent, antistatic agent, anti-fog agent, antimicrobial agent, colorant, laser marking additive, surface effect additive, radiation stabilizer, flame retardant, anti-drip agent may be present. The additive may have useful properties selected from optical properties, electrical properties, thermal properties, and mechanical properties (see also above).

The printable material in embodiments may comprise particulate material, i.e. particles embedded in the printable polymeric material, which particles form a substantially discontinuous phase. The number of particles in the total mixture is especially not larger than 60 vol. %, relative to the total volume of the printable material especially in applications for reducing thermal expansion coefficient. For optical and surface related effect number of particles in the total mixture is equal to or less than 20 vol. %, such as up to 10 vol. %, relative to the total volume of the printable material (including the particles). Hence, the 3D printable material especially refers to a continuous phase of essentially thermoplastic material, wherein other materials, such as particles, may be embedded. Likewise, the 3D printed material especially refers to a continuous phase of essentially thermoplastic material, wherein other materials, such as particles, are embedded. The particles may comprise one or more additives as defined above. Hence, in embodiments the 3D printable materials may comprises particulate additives.

The printable material is printed on a receiver item. Especially, the receiver item can be the building platform or can be comprised by the building platform. The receiver item can also be heated during 3D printing. However, the receiver item may also be cooled during 3D printing.

The phrase “printing on a receiver item” and similar phrases include amongst others directly printing on the receiver item, or printing on a coating on the receiver item, or printing on 3D printed material earlier printed on the receiver item. The term “receiver item” may refer to a printing platform, a print bed, a substrate, a support, a build plate, or a building platform, etc. Instead of the term “receiver item” also the term “substrate” may be used. The phrase “printing on a receiver item” and similar phrases include amongst others also printing on a separate substrate on or comprised by a printing platform, a print bed, a support, a build plate, or a building platform, etc. Therefore, the phrase “printing on a substrate” and similar phrases include amongst others directly printing on the substrate, or printing on a coating on the substrate or printing on 3D printed material earlier printed on the substrate. Here below, further the term substrate is used, which may refer to a printing platform, a print bed, a substrate, a support, a build plate, or a building platform, etc., or a separate substrate thereon or comprised thereby.

Layer by layer printable material is deposited, by which the 3D printed item is generated (during the printing stage). The 3D printed item may show a characteristic ribbed structure (originating from the deposited filaments). However, it may also be possible that after a printing stage, a further stage is executed, such as a finalization stage. This stage may include removing the printed item from the receiver item and/or one or more post processing actions. One or more post processing actions may be executed before removing the printed item from the receiver item and/or one more post processing actions may be executed after removing the printed item from the receiver item. Post processing may include e.g. one or more of polishing, coating, adding a functional component, cross-linking, etc. Post-processing may include smoothening the ribbed structures, which may lead to an essentially smooth surface. Post-processing may include cross-linking of the thermoplastic material. This may result in fewer or no thermoplastic properties of the material.

Further, the invention relates to a software product that can be used to execute the method described herein. Therefore, in yet a further aspect the invention also provides a computer program product, when running on a computer which is functionally coupled to or comprised by a fused deposition modeling 3D printer, is capable of bringing about the method as described herein.

Hence, in an aspect the invention (thus) provides a software product, which, when running on a computer is capable of bringing about (one or more embodiments of) the method (for producing a 3D item by means of fused deposition modelling) as described herein.

The herein described method provides 3D printed items. Hence, the invention also provides in a further aspect a 3D printed item obtainable with the herein described method. In a further aspect a 3D printed item obtainable with the herein described method is provided.

Especially, the invention provides a 3D item comprising 3D printed material, wherein the 3D item comprises a plurality of layers of 3D printed material, wherein at least one of the layers may comprise a core-shell layer of 3D printed material; wherein the core-shell layer may comprise (i) a core comprising a 3D printed core material, and (ii) a shell comprising a 3D printed shell material. Especially wherein the shell at least partly encloses the core. Especially, the 3D printed shell material may comprise particles having particle sizes, which may be transmissive or transparent for one or more wavelengths in the visible wavelength range, wherein at least part of a total number of particles may protrude from the shell of the 3D printed material, thereby providing a retroreflective shell.

Hence, in specific embodiments the invention provides a 3D item comprising 3D printed material, wherein the 3D item comprises a plurality of layers of 3D printed material, wherein at least one of the layers comprises a core-shell layer of 3D printed material; wherein the core-shell layer comprises (i) a core comprising a 3D printed core material, and (ii) a shell comprising a 3D printed shell material; wherein the shell at least partly encloses the core, wherein the 3D printed shell material comprises shell particles which are transparent for a wavelength in the visible wavelength range and wherein at least part of a total number of shell particles protrude from the shell of the 3D printed material (202).

The 3D printed item may comprise a plurality of layers on top of each other, i.e. stacked layers. The width (thickness) and height of (individually 3D printed) layers may e.g. in embodiments be selected from the range of 100-5000 μm, such as 200-2500 μm, with the height in general being smaller than the width. For instance, the ratio of height and width may be equal to or smaller than 0.8, such as equal to or smaller than 0.6.

Layers may be core-shell layers or may consist of a single material. Within a layer, there may also be a change in composition, for instance when a core-shell printing process was applied and during the printing process it was changed from printing a first material (and not printing a second material) to printing a second material (and not printing the first material).

At least part of the 3D printed item may include a coating.

Some specific embodiments in relation to the 3D printed item have already been elucidated above when discussing the method. Below, some specific embodiments in relation to the 3D printed item are discussed in more detail.

As indicated above, in embodiments, the 3D printed shell material is light transmissive, especially light transparent for the wavelength.

In embodiments, the 3D item comprises at least part of a layer wherein at least 20 vol. %, especially at least 40 vol. %, of the particles in the shell protrude the 3D printed material.

In embodiments (of the 3D item), the shell particles have an equivalent spherical diameter D1 in the range 30 μm≤D1≤2000 μm, such as in the range 30 μm≤D1≤1000 μm, especially in the range 60 μm≤D1≤850 μm, more especially in the range 80 μm≤D1≤700 μm. In embodiments, the shell has a shell width W2 0.5≤D1/W2≤1.5. In embodiments, the shell particles may be spherical, ellipsoid, cubic, prismoid, flakes, or irregularly shaped.

In embodiments, the shell particles have a refractive index selected from the range of 1.4-2.5, especially in the range of 1.5-1.9. Especially, the shell particles and the 3D printable (or printed) shell material may not have the same refractive index. In embodiments, the difference in refractive index is at least 0.05, like at least 0.1, like in the range 0.1-1.3, such as 0.1-0.5. In specific embodiments, the difference in refractive index is at least 0.15, such as in embodiments at least 0.2, such as in the range of 0.2-1.3, like 0.2-0.8. In specific embodiments, the 3D printed shell material comprises a thermoplastic material with the shell particles, wherein the shell particles have a first refractive index and the thermoplastic material has a second refractive index, wherein the first refractive index and second refractive index differ with at least 0.15.

As indicated herein, the 3D printed shell material comprises a thermoplastic material with the shell particles. At least part of the total number of shell particles may be partially embedded in the thermoplastic material. In embodiments, also at least part of the total number of shell particles may be fully embedded in the thermoplastic material. However, as indicated herein, at least part of the total number of shell particles may protrude from the thermoplastic material (of the shell of the core-shell layer).

In embodiments, the shell particles comprise one or more of (i) glass beads (especially barium titanate glass beads), (ii) polymer spheres, and (iii) quartz spheres.

In embodiments, the core printable material comprises core particles for providing the reflective or absorbing properties of the 3D printable core material.

In embodiments, the core particles are reflective for the wavelength, wherein the core particles are described by a length L_{1,1} and a second aspect ratio AR_{1,2}, wherein length L_{1,1} is in the range from 1-1000 μm, especially in the range from 5-500 μm, more especially in the range from 10-300 μm, wherein AR_{1,2}≥10, especially AR_{1,2}≥20, more especially AR_{1,2}≥40. Especially, wherein the core particles have a reflectivity R for the wavelength, wherein R>70%, especially R>80%, more especially R>85%.

In embodiments, the core particles are absorbing for the wavelength, and the core particles are described by a length L_{1,1}, a width L_{1,2}, a height L_{1,3}, a first aspect ratio AR_{1,1}, a second aspect ratio AR_{1,2} and a third aspect ratio AR_{1,3}, wherein length L_{1,1} is in the range from 1-100 μm, especially in the range from 5-80 μm, more especially in the range from 10-60 μm, and wherein AR_{1,1}≤2, AR_{1,2}≤2, and AR_{1,3}≤2. Hence, in embodiments L_{1,2} may be in the range of 0.5-50 μm. Alternatively or additionally, in embodiments L_{1,3} may be in the range of 0.5-50 μm.

In embodiments, the shell particles are described by a length L_{2,1}, a width L_{2,2} and a height L_{2,3} a first aspect ratio AR_{2,1}, a second aspect ratio AR_{2,2}, and a third aspect ratio AR_{2,3} wherein length L_{2,1} is in the range from 30-2000 μm, especially in the range from 30-1000 μm and wherein AR_{2,1}≤2, AR_{2,2}≤2, and AR_{2,3}≤2. Hence, in embodiments L_{2,2} may be in the range of 15-1000 μm. Alternatively or additionally, in embodiments L_{2,3} may be in the range of 15-1000 μm.

In embodiments (of the 3D item), the core and shell comprise the same thermoplastic material. This may provide core-shell layers that may be very well compatible.

In embodiments the 3D item comprises a first section wherein 0.25≤D1/W2≤2.5, in specific embodiments 0.5≤D1/W2≤1.5, such as D1/W2≥1.25, or even D1/W2≥1. Alternatively or additionally, the 3D item comprises a second section wherein D1/W2<0.5, or even D1/W2<0.25.

In specific embodiments, for at least part (or section) of a core-shell layer of 3D printed material may apply that the shell width W2 in relation to the equivalent spherical diameter D1 may comply with a ratio of 0.5≤D1/W2≤1.5. Alternatively or additionally, for at least another part (section) of a core-shell layer of 3D printed material may apply that the shell width W2 in relation to the equivalent spherical diameter D1 comply with a ratio D1/W2<0.5.

The sections may be adjacent. A section may comprise part of a layer. A section may comprise a plurality of layers. In embodiments, a section may define a cross-sectional area of the 3D item of at least 1 cm².

Especially, in embodiments a cross-sectional area of the 3D printed item comprising at least two, such as at least five, layer axes Ax, for which 0.5≤D1/W2≤1.5 applies, is larger than or equal to 5 cm², such as equal to or larger than 25 cm². Alternatively or additionally, in embodiments a cross-sectional area of the 3D printed item comprising at least two, such as at least five, layer axes Ax, for which D1/W2<0.5 applies, is larger than or equal to 5 cm², such as equal to or larger than 25 cm².

The (with the herein described method) obtained 3D printed item may be functional per se. For instance, the 3D printed item may be a lens, a collimator, a reflector, etc. The thus obtained 3D item may (alternatively) be used for decorative or artistic purposes. The 3D printed item may include or be provided with a functional component. The functional component may especially be selected from the group consisting of an optical component, an electrical component, and a magnetic component. The term “optical component” especially refers to a component having an optical functionality, such as a lens, a mirror, a light transmissive element, an optical filter, etc. The term optical component may also refer to a light source (like a LED). The term “electrical component” may e.g. refer to an integrated circuit, PCB, a battery, a driver, but also a light source (as a light source may be considered an optical component and an electrical component), etc. The term magnetic component may e.g. refer to a magnetic connector, a coil, etc. Alternatively, or additionally, the functional component may comprise a thermal component (e.g. configured to cool or to heat an electrical component). Hence, the functional component may be configured to generate heat or to scavenge heat, etc.

As indicated above, the 3D printed item maybe used for different purposes. Amongst others, the 3D printed item maybe used in lighting. Hence, in yet a further aspect the invention also provides a lighting device comprising the 3D item as defined herein. In a specific aspect the invention provides a lighting system comprising (a) a light source configured to provide (visible) light source light and (b) the 3D item as defined herein, wherein 3D item may be configured as one or more of (i) at least part of a housing, (ii) at least part of a wall of a lighting chamber, and (iii) a functional component, wherein the functional component may be selected from the group consisting of an optical component, a support, an electrically insulating component, an electrically conductive component, a thermally insulating component, and a thermally conductive component. Hence, in specific embodiments the 3D item may be configured as one or more of (i) at least part of a lighting device housing, (ii) at least part of a wall of a lighting chamber, and (iii) an optical element. As a relative smooth surface may be provided, the 3D printed item may be used as mirror or lens, etc. In embodiments, the 3D item may be configured as shade. A device or system may comprise a plurality of different 3D printed items, having different functionalities.

It may also be desirable to provide a filament which can be used in the herein described method. Therefore, in a further aspect, the invention provides 3D printable material, especially a core-shell filament comprising 3D printable core material and 3D printable shell material, wherein the 3D printable shell material comprises particles. Such 3D printable material, especially such filament, can be printed in a standard fused deposition modeling 3D printer with a single nozzle.

Returning to the 3D printing process, a specific 3D printer may be used to provide the 3D printed item described herein. Therefore, in yet a further aspect the invention also provides a fused deposition modeling 3D printer, comprising (a) a printer head comprising a printer nozzle, and (b) a 3D printable material providing device configured to provide 3D printable material to the printer head, wherein the fused deposition modeling 3D printer is configured to provide said 3D printable material as indicated above.

The printer nozzle may include a single opening. In other embodiments, the printer nozzle may be of the core-shell type, having two (or more) openings. In embodiments, the nozzle may be of the core-shell-shell type, wherein two or more shell nozzles at least partly enclose the core nozzle. In embodiments, each shell nozzle may only be separated from the core nozzle by a shared nozzle wall (shared with the core nozzle). The term “printer head” may also refer to a plurality of (different) printer heads; hence, the term “printer nozzle” may also refer to a plurality of (different) printer nozzles.

The 3D printable material providing device may provide a filament comprising 3D printable material to the printer head or may provide the 3D printable material as such, with the printer head creating the filament comprising 3D printable material. Hence, in embodiments the invention provides a fused deposition modeling 3D printer, comprising (a) a printer head comprising a printer nozzle, and (b) a filament providing device configured to provide a filament comprising 3D printable material to the printer head, wherein the fused deposition modeling 3D printer is configured to provide said 3D printable material to a substrate, as indicated above.

Especially, the 3D printer comprises a controller (or is functionally coupled to a controller) that is configured to execute in a controlling mode (or “operation mode”) the method as described herein. Instead of the term “controller” also the term “control system” (see e.g. above) may be applied. The term “controlling” and similar terms especially refer at least to determining the behavior or supervising the running of an element. Hence, herein “controlling” and similar terms may e.g. refer to imposing behavior to the element (determining the behavior or supervising the running of an element), etc., such as e.g. measuring, displaying, actuating, opening, shifting, changing temperature, etc. Beyond that, the term “controlling” and similar terms may additionally include monitoring. Hence, the term “controlling” and similar terms may include imposing behavior on an element and also imposing behavior on an element and monitoring the element. The controlling of the element can be done with a control system, which may also be indicated as “controller”. The control system and the element may thus at least temporarily, or permanently, functionally be coupled. The element may comprise the control system. In embodiments, the control system and element may not be physically coupled. Control can be done via wired and/or wireless control. The term “control system” may also refer to a plurality of different control systems, which especially are functionally coupled, and of which e.g. one control system may be a master control system and one or more others may be slave control systems. A control system may comprise or may be functionally coupled to a user interface. The control system may also be configured to receive and execute instructions form a remote control. In embodiments, the control system may be controlled via an App on a device, such as a portable device, like a Smartphone or iPhone, a tablet, etc. The device is thus not necessarily coupled to the lighting system, but may be (temporarily) functionally coupled to the lighting system. Hence, in embodiments the control system may (also) be configured to be controlled by an App on a remote device. In such embodiments the control system of the lighting system may be a slave control system or control in a slave mode. For instance, the lighting system may be identifiable with a code, especially a unique code for the respective lighting system. The control system of the lighting system may be configured to be controlled by an external control system which has access to the lighting system on the basis of knowledge (input by a user interface of with an optical sensor (e.g. QR code reader) of the (unique) code. The lighting system may also comprise means for communicating with other systems or devices, such as based on Bluetooth, WIFI, LiFi, ZigBee, BLE or WiMAX, or another wireless technology. The system, or apparatus, or device may execute an action in a “mode” or “operation mode” or “mode of operation”. Likewise, in a method an action or stage, or step may be executed in a “mode” or “operation mode” or “mode of operation” or “operational mode”. The term “mode” may also be indicated as “controlling mode”. This does not exclude that the system, or apparatus, or device may also be adapted for providing another controlling mode, or a plurality of other controlling modes. Likewise, this may not exclude that before executing the mode and/or after executing the mode one or more other modes may be executed. However, in embodiments a control system may be available, that is adapted to provide at least the controlling mode. Would other modes be available, the choice of such modes may especially be executed via a user interface, though other options, like executing a mode in dependence of a sensor signal or a (time) scheme, may also be possible. The operation mode may in embodiments also refer to a system, or apparatus, or device, that can only operate in a single operation mode (i.e. “on”, without further tunability). Hence, in embodiments, the control system may control in dependence of one or more of an input signal of a user interface, a sensor signal (of a sensor), and a timer. The term “timer” may refer to a clock and/or a predetermined time scheme.

Instead of the term “fused deposition modeling (FDM) 3D printer” shortly the terms “3D printer”, “FDM printer” or “printer” may be used. The printer nozzle may also be indicated as “nozzle” or sometimes as “extruder nozzle”.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIGS. 1a-1c schematically depict some general aspects of the 3D printer and of an embodiment of 3D printed material;

FIGS. 2a-2d schematically depict some further aspects of the method and of the 3D printed material of the invention;

FIGS. 3a-3c schematically depict some aspects of embodiments of particles;

FIG. 4 schematically depicts the mechanism for retroreflection;

FIG. 5 schematically depicts an application;

FIG. 6 is a photograph of a 3D printed item according to the present invention; and

FIG. 7 is a photograph of a 3D printed item according to the present invention.

The schematic drawings are not necessarily to scale.

### DETAILED DESCRIPTION OF THE EMBODIMENTS

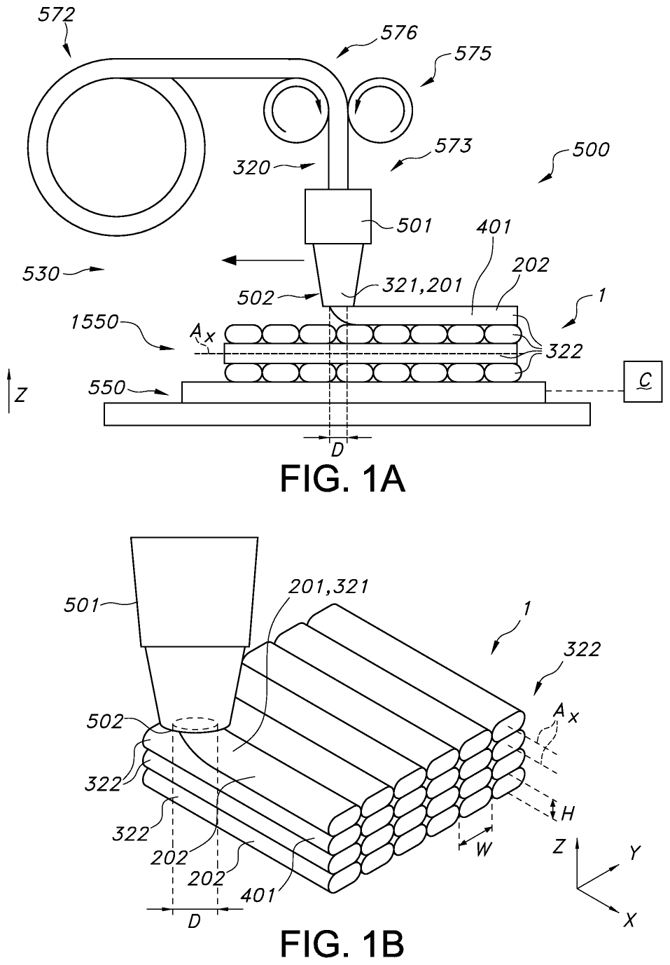

FIG. 1a schematically depicts some aspects of the 3D printer. Reference 500 indicates a 3D printer. Reference 530 indicates the functional unit configured to 3D print, especially FDM 3D printing; this reference may also indicate the 3D printing stage unit. Here, only the printer head for providing 3D printed material, such as an FDM 3D printer head is schematically depicted. Reference 501 indicates the printer head. The 3D printer of the present invention may especially include a plurality of printer heads (see below). Reference 502 indicates a printer nozzle. The 3D printer of the present invention may especially include a plurality of printer nozzles, though other embodiments are also possible. Reference 320 indicates a filament of printable 3D printable material (such as indicated above). For the sake of clarity, not all features of the 3D printer have been depicted, only those that are of especial relevance for the present invention (see further also below). Reference 321 indicates extrudate (of 3D printable material 201).

The 3D printer 500 is configured to generate a 3D item 1 by layer-wise depositing on a receiver item 550, which may in embodiments at least temporarily be cooled, a plurality of layers 322 wherein each layers 322 comprises 3D printable material 201, such as having a melting point Tₘ. The 3D printable material 201 may be deposited on a substrate 1550 (during the printing stage). By deposition, the 3D printable material 201 has become 3D printed material 202. 3D printable material 201 escaping from the nozzle 502 is also indicated as extrudate 321. Reference 401 indicates thermoplastic material.

The 3D printer 500 may be configured to heat the filament 320 material upstream of the printer nozzle 502. This may e.g. be done with a device comprising one or more of an extrusion and/or heating function. Such device is indicated with reference 573 and is arranged upstream from the printer nozzle 502 (i.e. in time before the filament material leaves the printer nozzle 502). The printer head 501 may (thus) include a liquefier or heater. Reference 201 indicates printable material. When deposited, this material is indicated as (3D) printed material, which is indicated with reference 202.

Reference 572 indicates a spool or roller with material, especially in the form of a wire, which may be indicated as filament 320. The 3D printer 500 transforms this in an extrudate 321 downstream of the printer nozzle which becomes a layer 322 on the receiver item or on already deposited printed material. In general, the diameter of the extrudate 321 downstream of the nozzle 502 is reduced relative to the diameter of the filament 322 upstream of the printer head 501. Hence, the printer nozzle is sometimes (also) indicated as extruder nozzle. Arranging layer 322 by layer 322, a 3D item 1 may be formed. Reference 575 indicates the filament providing device, which here amongst others include the spool or roller and the driver wheels, indicated with reference 576.

Reference Ax indicates a longitudinal axis or filament axis.

Reference C schematically depicts a control system, such as especially a temperature control system configured to control the temperature of the receiver item 550. The control system C may include a heater which is able to heat the receiver item 550 to at least a temperature of 50° C., but especially up to a range of about 350° C., such as at least 200° C.

Alternatively or additionally, in embodiments the receiver plate may also be moveable in one or two directions in the x-y plane (horizontal plane). Further, alternatively or additionally, in embodiments the receiver plate may also be rotatable about z axis (vertical). Hence, the control system may move the receiver plate in one or more of the x-direction, y-direction, and z-direction.

Alternatively, the printer can have a head that can also rotate during printing. Such a printer has an advantage that the printed material cannot rotate during printing.

Layers are indicated with reference 322, and have a layer height H and a layer width W.

Note that the 3D printable material is not necessarily provided as filament 320 to the printer head. Further, the filament 320 may also be produced in the 3D printer 500 from pieces of 3D printable material.

Reference D indicates the diameter of the nozzle (through which the 3D printable material 201 is forced).

FIG. 1b schematically depicts in 3D in more detail the printing of the 3D item 1 under construction. Here, in this schematic drawing the ends of the filaments 321 in a single plane are not interconnected, though in reality this may in embodiments be the case. Reference H indicates the height of a layer. Layers are indicated with reference 322. The layers may have an essentially circular cross-section. Often, however, they may be flattened, such as having an outer shape resembling a flat oval tube or flat oval duct (i.e. a circular shaped bar having a diameter that is compressed to have a smaller height than width, wherein the sides (defining the width) are (still) rounded).

Hence, FIGS. 1a-1b schematically depict some aspects of a fused deposition modeling 3D printer 500, comprising (a) a first printer head 501 comprising a printer nozzle 502, (b) a filament providing device 575 configured to provide a filament 321 comprising 3D printable material 201 to the first printer head 501, and optionally (c) a receiver item 550. In FIGS. 1a-1b, the first or second printable material or the first or second printed material are indicated with the general indications printable material 201 and printed material 202, respectively. Directly downstream of the nozzle 502, the filament 321 with 3D printable material becomes, when deposited, layer 322 with 3D printed material 202.

FIG. 1c schematically depicts a stack of 3D printed layers 322, each having a layer height H and a layer width W. Note that in embodiments the layer width and/or layer height may differ for two or more layers 322. Reference 252 in FIG. 1c indicates the item surface of the 3D item (schematically depicted in FIG. 1c).

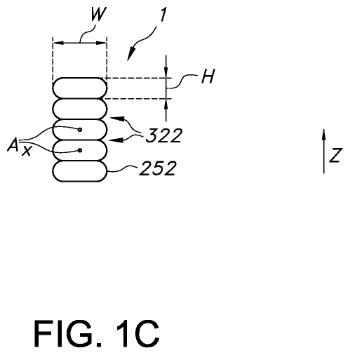

Referring to FIGS. 1a-1c, the filament of 3D printable material that is deposited leads to a layer having a height H (and width W). Depositing layer 322 after layer 322, the 3D item 1 is generated. FIG. 1c very schematically depicts a single-walled 3D item 1. FIGS. 2a-2e schematically depicts some further aspects of the method of the invention. FIGS. 2a-2b depict some embodiments of a (core-shell) filament 320 that may be used in the method. The filaments 320 may be used in a printer 500, e.g. as depicted in FIG. 1a-1b, having a nozzle 502 with a single opening. The geometry, especially the width of the core W1F, height of the core H1F and the width (or thickness) of the shell W2F in the filaments are indicated. In the embodiment of FIG. 2b, the shell material 341 comprising shell polymeric material 345 completely enclosing the core material 331 (comprising core polymeric materials 335) (W2F is non-zero at all locations along the perimeter of the filament 320).

In embodiments depicted in FIG. 2a-b, the filament 320 comprises (i) core material 331 comprising a printable core material 1351, comprising core particles 420 and (ii) a shell material 341 comprising a printable shell material 1361, comprising shell particles 430. In the embodiment of FIG. 2a, the shell material 341 only partly encloses the core material 331. The shell material 341 does not enclose the core material 331 at the two locations indicated by the arrows; at these locations W2F is zero (0 μm). As such, the shell material 341 of the filament 320 covers (encloses) the core material 331 of the filament 320 at two continuous sections arranged at a surface of the filament 320, where W2F is non-zero. Using the filament 320 of FIG. 2b in the 3D printing stage may in embodiments result in the 3D item 1 depicted in FIG. 2d.

Referring to FIGS. 2a-2b, the shell may partly enclose the core (see FIG. 2a) or fully enclose the core (see FIG. 2b).

Additionally to or as an alternative to using core-shell filaments, a core-shell nozzle 502 may be used as is schematically illustrated in FIG. 2c. Filaments 320 comprising 3D printable core material 1351 and shell printable material 1361 enter printing head 501 in the core nozzle 5025 and shell nozzle 5026, respectively. The 3D printable core material 1351 may comprise particles 420, the shell printable material 1361 may comprise particles 430. After extrusion, a core-shell layer 1322 is deposited comprising a core 330 comprising core material 331, comprising core printed material 1352; and a shell 340 comprising shell material 341, comprising shell printed material 1362.

In embodiments, the particle sizes are selected such that the core particles 420 can pass through the core nozzle 5025 and that the shell particles 430 can pass through the shell nozzle 5026 without clog formation. Relative extrusion rates of core printing material 1351, shell printing material 1361 and substrate 550 may be selected such that shell width W2 is controlled in relation to the particle equivalent spherical diameter D1 in a first stage following 0.5≤D1/W2≤1.5 resulting in shell particles 430 protruding from the shell 340 to obtain a retroreflective 3D item 1.

FIG. 2d schematically depicts a stack of 3D printed core-shell layers 1322. The layers comprise core-shell layer 1322 of 3D printed material 202 and comprising a core 330 and a shell 340. The core 330 comprises a core material 331 comprising a first composition. The shell 340 comprises a shell material 341 comprising a second composition different from the first composition, e.g. in physical, chemical, and/or optical properties. In embodiments, the core printed material 1352 comprises core particles 420. The core particles may be absorbing or reflective. Different types of core particles 420 may be combined in one 3D item 1. FIG. 2d depicts a stack of four core-shell layers 1322 printed according to the present invention, resulting in core-shell layers 1322 with shell particles 430 protruding from the shell 340 of the 3D printed item 1. In embodiments, the core particles 420 in the two top layers 322 may be reflective whereas the core particles 420 in the two bottom layers 332 may be absorbing.

In the exemplary layers of FIG. 2d, the shell fully encloses the core.

In embodiments, the shell printed material 1362 comprises particles 430. Further, the core height of the core 330 is indicated with reference H1, and the width of the core is indicated with reference W1. The shell 340 has a shell width W2. The shell width W2 may herein also be referred to as thickness W2 of the shell 340. FIG. 2d depicts an embodiment wherein (in each core-shell layer 1322) the shell 340 substantially completely encloses the core 330.

Further, as shown in FIG. 2d, the width W1 of the core and the width W2 of the shell may be determined essentially perpendicular to the stacking height. Further, the height of the core H1 may be determined essentially parallel to the stacking height. The term “shell width” may especially refer to the largest shell width. The term “core height” may also especially refer to the largest core height. The term “core width” may also especially refer to the largest core width. Especially, the largest shell width is the width of the shell in the same plane as the largest core width.

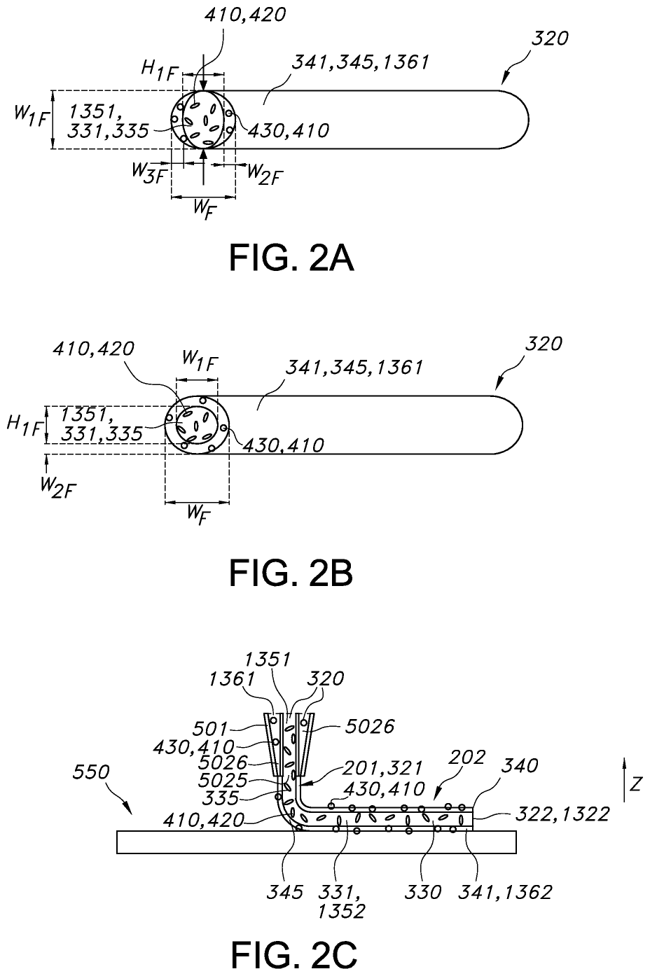

FIGS. 3a-3c schematically depict embodiments of particles 410. FIG. 3a depicts a spherical particle 410 and ellipsoid particle 410. The length L₁, width L₂, and height L₃ of the spherical particle 410 are all equal to its diameter. The length L₁, width L₂, and height L₃ of the ellipsoid particle 410 are defined by a virtual smallest rectangular prism 415 enclosing the particle. The rectangular prism 415 has a length L₁, a width L₂ and a height L₃ wherein L₁≥L₂≥L₃. FIG. 3b depicts a particle 410 that has a rectangular prism shape, wherein the rectangular prism 415 has a length L₁, a width L₂ and a height L₃ wherein L₁≥L₂≥L₃. FIG. 3c schematically depicts a particle that has a curved shape, with a virtual smallest rectangular prism 415 enclosing the particle. The rectangular prism 415 has a length L₁, a width L₂ and a height L₃ wherein L₁≥L₂≥L₃.

Further, note that the particles are not essentially oval or rectangular prismoids. Of course, the particles may comprise a combination of differently shaped particles.

Shell particle dimensions and core particle dimensions are defined analogously to the particle dimensions described above by a virtual smallest rectangular prism 415 enclosing the core or shell particle. Core particles 420 may thus be described by a length L_{1,1}, a width L_{1,2}, a height L_{1,3}, a first aspect ratio AR_{1,1}, a second aspect ratio AR_{1,2} and a third aspect ratio AR_{1,3}. Hence, shell particles 430 may be described a length L_{2,1}, a width L_{2,2}, a height L_{2,3}, a first aspect ratio AR_{2,1}, a second aspect ratio AR_{2,2} and a third aspect ratio AR_{2,3}. Also, the particulate material that is embedded in the 3D printable material or is embedded in the 3D printed material may include a broad distribution of particles sizes.

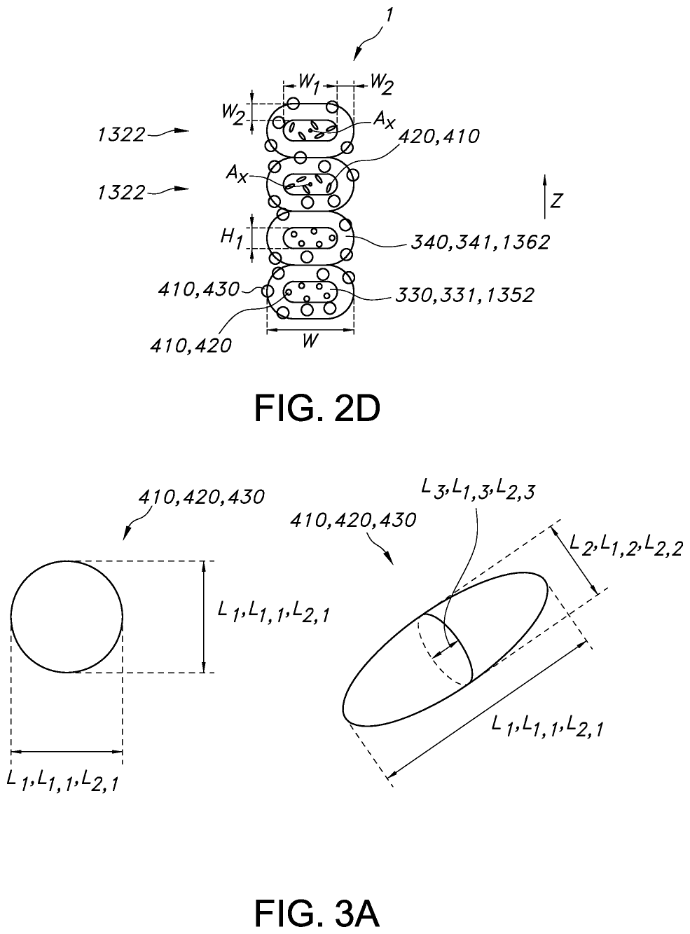

FIG. 4 depicts the mechanism of retroreflection by 3D item 1. Shell particles 430 are partially embedded in 3D printed material 202 and partially protruding from a surface of the 3D printed item 1. Light with a wavelength 21 in the visible wavelength range is transmitted through the shell particle 430 and reflected by the 3D printed material 202. The shell particle 430 acts as a lens and in combination with the reflective 3D printed material reflects the light in its original direction, thus is retroreflecting the wavelength 21.

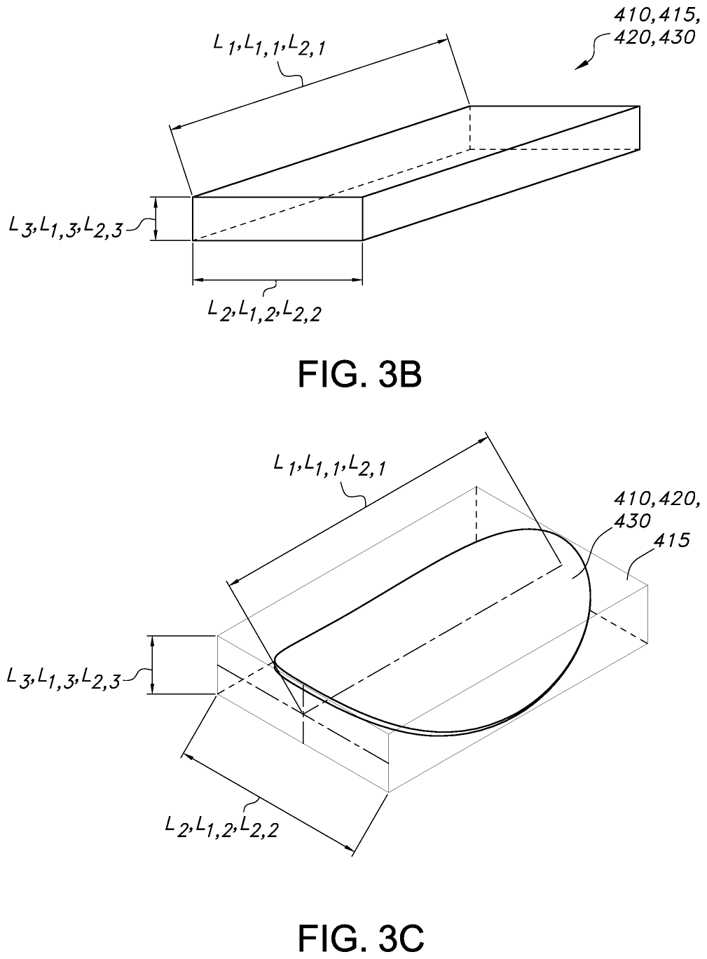

FIG. 5 schematically depicts an embodiment of a lamp or luminaire, indicated with reference 2, which comprises a light source 10 for generating light 11. The lamp may comprise a housing or shade or another element, which may comprise or be the 3D printed item 1. Here, the half sphere (in cross-sectional view) schematically indicates a housing or shade. The lamp or luminaire may be or may comprise a lighting device 1000 (which comprises the light source 10). Hence, in specific embodiments the lighting device 1000 comprises the 3D item 1. The 3D item 1 may be configured as one or more of (i) at least part of a lighting device housing, (ii) at least part of a wall of a lighting chamber, and (iii) an optical element. Hence, the 3D item may in embodiments be reflective for light source light 11 and/or transmissive for light source light 11. Here, the 3D item may e.g. be a housing or shade.

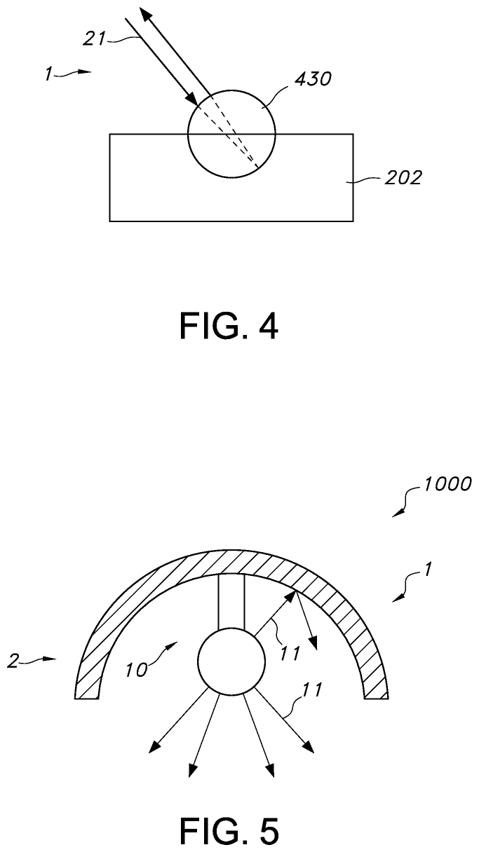

FIG. 6 depicts a photograph of the surface of a retroreflective 3D printed item wherein the core of the 3D printed item is light reflective.

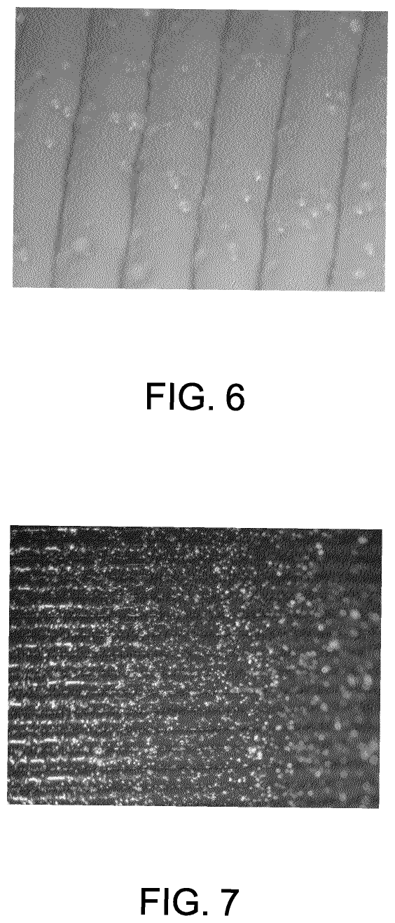

FIG. 7 depicts a photograph of the surface of a retroreflective 3D printed item wherein the core of the 3D printed item is light absorbing.

The term “plurality” refers to two or more.

The terms “substantially” or “essentially” herein, and similar terms, will be understood by the person skilled in the art. The terms “substantially” or “essentially” may also include embodiments with “entirely”, “completely”, “all”, etc. . . . . Hence, in embodiments the adjective substantially or essentially may also be removed. Where applicable, the term “substantially” or the term “essentially” may also relate to 90% or higher, such as 95% or higher, especially 99% or higher, even more especially 99.5% or higher, including 100%.

The term “comprise” also includes embodiments wherein the term “comprises” means “consists of”.

The term “and/or” especially relates to one or more of the items mentioned before and after “and/or”. For instance, a phrase “item 1 and/or item 2” and similar phrases may relate to one or more of item 1 and item 2. The term “comprising” may in an embodiment refer to “consisting of” but may in another embodiment also refer to “containing at least the defined species and optionally one or more other species”.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

The devices, apparatus, or systems may herein amongst others be described during operation. As will be clear to the person skilled in the art, the invention is not limited to methods of operation, or devices, apparatus, or systems in operation.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim.

Use of the verb “to comprise” and its conjugations does not exclude the presence of elements or steps other than those stated in a claim. Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

The article “a” or “an” preceding an element does not exclude the presence of a plurality of such elements.

The invention may be implemented by means of hardware comprising several distinct elements, and by means of a suitably programmed computer. In a device claim, or an apparatus claim, or a system claim, enumerating several means, several of these means may be embodied by one and the same item of hardware. The mere fact that certain measures are recited in mutually different dependent claims does not indicate that a combination of these measures cannot be used to advantage.

The invention also provides a control system that may control the device, apparatus, or system, or that may execute the herein described method or process. Yet further, the invention also provides a computer program product, when running on a computer which is functionally coupled to or comprised by the device, apparatus, or system, controls one or more controllable elements of such device, apparatus, or system.

The invention further applies to a device, apparatus, or system comprising one or more of the characterizing features described in the description and/or shown in the attached drawings. The invention further pertains to a method or process comprising one or more of the characterizing features described in the description and/or shown in the attached drawings.

The various aspects discussed in this patent can be combined in order to provide additional advantages. Further, the person skilled in the art will understand that embodiments can be combined, and that also more than two embodiments can be combined. Furthermore, some of the features can form the basis for one or more divisional applications.

It goes without saying that one or more of the first (printable or printed) material and second (printable or printed) material may contain fillers such as glass and fibers which do not have (to have) influence on the on T_{g} or Tₘ of the material(s).

1. A method for producing a 3D item by means of fused deposition modelling, the method comprising a 3D printing stage, wherein the 3D printing stage comprises:
layer-wise depositing 3D printable material to provide the 3D item comprising 3D printed material, wherein:
the 3D printable material comprises 3D printable core material and 3D printable shell material; wherein the 3D item comprises a core-shell layer of the 3D printed material, wherein the core-shell layer comprises (i) a core comprising 3D printed core material and (ii) a shell comprising 3D printed shell material; at least partly encloses the core; and
the 3D printable shell material comprises shell particles which are transparent for a wavelength in the visible wavelength range, and wherein at least part of a total number of shell particles of the 3D printed material.

2. The method according to claim 1, wherein the 3D printable shell material is light transparent for the wavelength; and wherein the shell particles are transparent for wavelengths in a wavelength range of at least 100 nm.

3. The method according to claim 1, wherein the shell particles have an equivalent spherical diameter D1 selected from the range of 30 μm≤D1≤2000 μm, and wherein the shell has a shell width W2, wherein 0.5≤D1/W2≤1.5.

4. The method according to claim 1, wherein the 3D printable shell material comprises a thermoplastic material, with the shell particles, wherein the shell particles have a first refractive index and the thermoplastic material has a second refractive index, wherein the first refractive index and second refractive index differ with at least 0.15.

5. The method according to claim 1, wherein the shell particles comprise one or more of (i) glass beads, and (ii) polymer spheres.

6. The method according to claim 1, wherein the 3D printable core material is reflective or absorbing for the wavelength, wherein the 3D printable core material comprises core particles, wherein the core particles are each individually described by a smallest rectangular prism circumscribing the respective particles, wherein the rectangular prism has a length L₁, a width L₂ and a height L₃, wherein L₁≥L₂≥L₃, wherein the rectangular prism has a first aspect ratio is AR₁=L₁/L₂, a second aspect ratio is AR₂=L₁/L₃, and a third aspect ratio is AR₃=L₂/L₃, wherein:
the shell particles are described by a length L_{2,1}, a first aspect ratio AR_{2,1}, a second aspect ratio AR_{2,2}, and a third aspect ratio AR_{2,3} wherein length L_{2,1} is in the range from 30-2000 μm and wherein AR_{2,1}≤2, AR_{2,2}≤2, and AR_{2,3}≤2.

7. The method according to claim 6, wherein the core particles are reflective for the wavelength, wherein the core particles are described by a length L_{1,1} and a second aspect ratio AR_{1,2}, wherein length L_{1,1} is in the range from 1 μm, wherein AR_{1,2}≥10.

8. The method according to claim 6, wherein the core particles are absorbing for the wavelength, wherein the core particles are described by a length L_{1,1} and a first aspect ratio AR_{1,1}, a second aspect ratio AR_{1,2} and a third aspect ratio AR_{1,3}, wherein length L_{1,1} is in the range from 1-100 μm, and wherein AR_{1,1}≤2, AR_{1,2}≤2, and AR_{1,3}≤2.

9. The method according to claim 1, wherein a shrinkage of the 3D printed shell material is higher than a shrinkage of the 3D printed core material.

10. A 3D item comprising 3D printed material, wherein the 3D item comprises a plurality of layers of 3D printed material, wherein at least one of the layers comprises a core-shell layer of 3D printed material; wherein the core-shell layer, comprises (i) a core comprising a 3D printed core material, and (ii) a shell comprising a 3D printed shell material; wherein the shell at least partly encloses the core, wherein the 3D printed shell material comprises shell particles which are transparent for a wavelength in the visible wavelength range and wherein at least part of a total number of shell particles protrude from the shell of the 3D printed material.

11. The 3D item according to claim 10, wherein the shell particles have an equivalent spherical diameter D1, wherein 30 μm≤D1≤2000 μm, and wherein the shell has a shell width W2, wherein 0.5≤D1/W2≤1.5, wherein the 3D printed shell material comprise a thermoplastic material with the shell particles, wherein the shell particles have a first refractive index and the thermoplastic material has a second refractive index, wherein the first refractive index and second refractive index differ with at least 0.15.

12. The 3D item according to claim 10, wherein the 3D printed core material is reflective or absorbing for the wavelength, wherein the 3D printed core material comprises core particles, wherein the core particles and shell particles are each individually described by a smallest rectangular prism circumscribing the respective particles, wherein the rectangular prism has a length L₁, a width L₂ and a height L₃, wherein L₁≥L₂≥L₃, wherein the rectangular prism has a first aspect ratio is AR₁=L₁/L₂, a second aspect ratio is AR₂=L₁/L₃, and a third aspect ratio is AR₃=L₂/L₃, wherein:
the shell particles are described by a length L_{2,1}, a first aspect ratio AR_{2,1}, a second aspect ratio AR_{2,2}, and a third aspect ratio AR_{2,3} wherein length L_{2,1} is in the range from 30-2000 μm and wherein AR_{2,1}≤2, AR_{2,2}≤2, and AR_{2,3}≤2;
the core particles comprise reflective particles, wherein the core particles are described by a length L_{1,1} and a second aspect ratio AR_{1,2}, wherein length L_{1,1} is in the range from 1-1000 μm and wherein AR_{1,2}≥10.

13. The 3D item according to claim 10, wherein the shell particles comprise glass beads, and wherein the 3D printed shell material is light transparent for the wavelength.

14. A lighting device comprising the 3D item according to claim 10, wherein the 3D item is configured as one or more of (i) at least part of a lighting device housing, (ii) at least part of a wall of a lighting chamber, and (iii) an optical element.
